(19) United States
(12) Patent Application Publication
(10) Pub. No.: US 2015/0336811 A1
(43) Pub. Date: Nov. 26, 2015

(54) Particle Separator

(71) Applicant: Johnson Electric S.A., Murten (CH)

(72) Inventors: Chad J. CAPARROS, Shenzhen (CN); Serge PESETSKY, Shenzhen (CN); Chuan Hui FANG, Hong Kong (CN)

(21) Appl. No.: 14/718,359

(22) Filed: May 21, 2015

(30) Foreign Application Priority Data
May 21, 2014 (CN) 201410214620.5

(51) Int. Cl. C02F 1/38

(52) U.S. Cl. CPC C02F 1/38

(57) ABSTRACT

A particle separator includes a particle separation member having a plurality of conical cavities for separating particles from unclean liquid; a fluid distribution member for distributing the unclean liquid to the cavities; a particle collection member for collecting the separated particles; and a fluid guiding member for guiding cleaned liquid to an outlet. Each cavity has a narrow open end and a wide open end. A vortex finder is disposed in each of the cavities. An entry channel for the liquid has an inlet section arranged between two adjacent cavities of the particle separation member.

### CROSS REFERENCE TO RELATED APPLICATIONS

This non-provisional patent application claims priority under 35 U.S.C. §119(a) from Patent Application No. 201410214620.5 filed in The People's Republic of China on May 21, 2014, the entire contents of which are hereby incorporated by reference.

### FIELD OF THE INVENTION

This invention relates to a particle separator and in particular, to a particle separator for a water system such as a domestic water supply system or a central heating system.

### BACKGROUND OF THE INVENTION

Large cyclonic separation devices are used in industry, such as used in oil refineries to separate oils and gases and in swimming pools to separate particles from water, through vortex separation. The size of these kinds of devices are always large and unsuitable for domestic applications.

There are few small particle separators for domestic, water based boiler systems on the market. However, dirt, debris including compounds such as Fe₂O₃ and Fe₃O₄ and sludge present in central heating systems, deposits on walls of pipes and heat exchanges causing lower efficiency of the boiler system, especially the pump by increasing the flow resistance.

Current particle separators generally include several separate separation channels evenly distributed along the circumference thereof. An inlet section is disposed between two adjacent separation channels. Water flows into the inlet section and then enters the separation channels. Due to limited space available between two adjacent separation channels, the diameter of the inlet section is restricted, thus the flow rate of the particle separator is limited.

Hence there is a desire for a new small particle separator for a water system such as a domestic water supply system or central heating system which addresses at least one of the afore-mentioned problems.

### SUMMARY OF THE INVENTION

Accordingly, in one aspect thereof, the present invention provides a particle separator comprising: a particle separation member configured to separate particles from unclean liquid, the particle separation member comprising an entry channel and a plurality of cavities each having a narrow open end, a wide open end and a conical part between the narrow and wide open ends; a fluid distribution member configured to distribute the unclean liquid to the cavities; a particle collection member in communication with the narrow open ends of the cavities and arranged to collect particles separated from the liquid; a fluid guiding member configured to guide liquid from the particle separation member to an outlet of the device; and a plurality of vortex finders disposed between the wide open end of each of the cavities of the particle separation member and the fluid guiding member; wherein the entry channel comprises an inlet section extending in a radial direction of the particle separation member, and an outlet section extending in an axial direction of the particle separation member; and the inlet section is disposed between two adjacent cavities of the particle separation member, and the distance between said two adjacent cavities greater than the distance between other adjacent cavities.

Preferably, the inlet section is located outside of a chamber of the particle collection member.

Preferably, the wide open end of each cavity further comprises a cylindrical extension portion, and each vortex finder is disposed in the cylindrical extension portion of a corresponding cavity.

Preferably, the outlet section of the entry channel has a conical distal end, the diameter of which gradually increases in a direction away from the inlet section, and the start sections of the distribution passages are connected to the conical distal end.

Preferably, the fluid distribution member further comprises a protrusion located between the start sections of the distribute passages, the protrusion having a curved surface facing the conical distal end of the entry channel.

Preferably, the inlet section is located outside of a chamber of the particle collection member, wherein the particle separation member is integrally formed with a plurality of voids and walls formed between the voids.

Preferably, the wide open end of each cavity further comprises a cylindrical extension portion, and the skirt portion of each vortex finder is disposed in the cylindrical extension portion of a corresponding cavity.

Preferably, the fluid distribution member comprises a plurality of distribution passages each having a start section, a cylindrical section connected to the cylindrical extension portion of a corresponding cavity, and a transition section connecting the start section to the cylindrical section, the transition section joining the cylindrical section in a tangential manner.

Preferably, a bottom surface of the transition section facing the particle separation member is curved.

Preferably, each vortex finder has a cylindrical body with a central passage connecting the cavities with the fluid guiding member, a skirt portion and a distal end adjacent the skirt portion and having a reduced wall thickness, the skirt portion being located at the wide open end of the corresponding cavity.

Preferably, an outer surface of the distal end of each vortex finder forms a step with the skirt portion.

Preferably, the distal end of each vortex finder has an inclined inner surface.

Preferably, the particle collection member comprises a chamber, a magnet cover detachably covers the chamber and a ring magnet is fixed to an inner surface of the magnet cover.

Preferably, pressure sensors are respectively disposed in the particle separation member and the fluid guiding member.

Preferably, a pH sensor is disposed in the fluid guiding member.

Preferably, the particle separation member, fluid guiding member, and particle collection member are made from transparent or translucent materials.

Preferably, the materials of the particle separation member are thermally stable plastics materials reinforced with mica particles, glass fibers or carbon micro and nano-fibers.

Preferably, surfaces for guiding liquid are modified with polymers selected from the group of fluorodecyl polyhedral oligomeric silsesquioxanes.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a plan view of a particle separator in accordance with a preferred embodiment of the present invention;

FIG. 2 is a sectional view along B-B line, of the particle separator of FIG. 1;

FIG. 3 illustrates a particle separation member of the particle separator of FIG. 1, with a fluid guiding member and a fluid distribution member removed;

FIG. 4 illustrates the fluid distribution member;

FIG. 5 illustrates a vortex finder of the particle separator of FIG. 1;

FIG. 6 is a sectional view of the vortex finder of FIG. 5;

FIG. 7 illustrates a particle separation member with a fluid guiding member and a fluid distribution member removed, in accordance with a second embodiment of the present invention;

FIG. 8 illustrates a fluid distribution member corresponding to the particle separation member of FIG. 7;

FIG. 9 illustrates another fluid distribution member in accordance with a further embodiment of the present invention; and

FIG. 10 is a sectional view of a particle separator in accordance with another embodiment of the present invention.

### DETAILED DESCRIPTION OF THE PREFERRED EMBODIMENTS

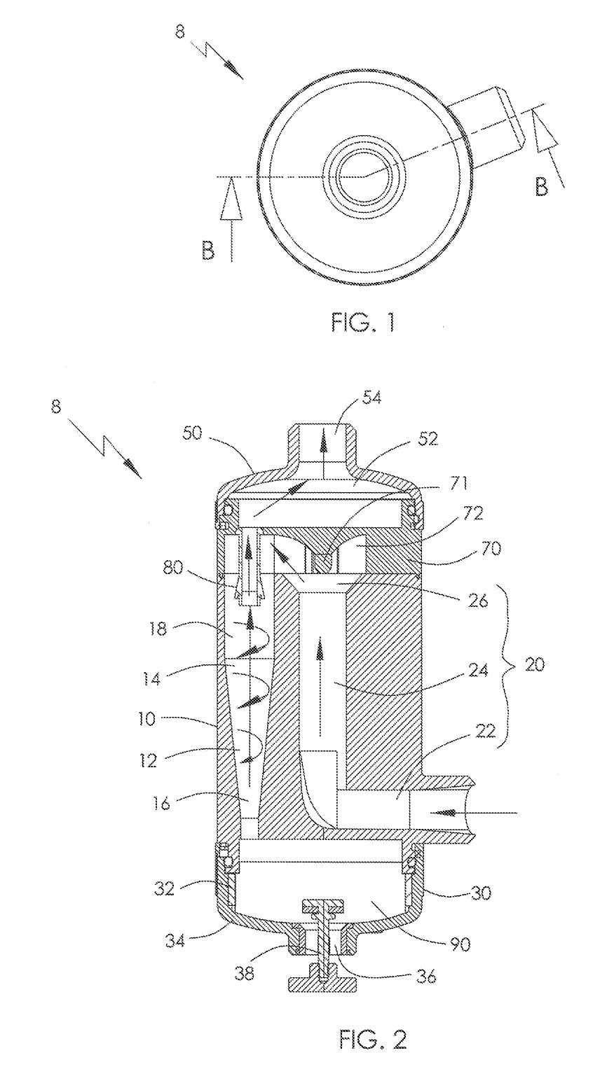

FIGS. 1 and 2 illustrate a particle separator 8 according to a preferred embodiment of the present invention. The particle separator comprises a particle separation member 10 configured for separating particles from unclean liquid, a particle collection member 30 in communication with the particle separation member 10 and configured to collect particles separated from the liquid by the particle separation member 10, and a fluid guiding member 50 in communication with the particle separation member 10 configured for guiding clean liquid coming from the particle separation member 10 to an outlet 54 of the device. The liquid flows in a direction as indicated by arrows in FIG. 2.

The fluid guiding member 50 includes a chamber 52 and the outlet 54. The liquid flows from the particle separation member 10 into the chamber 52 and then out the outlet 54.

The particle separation member 10 comprises a plurality of cavities 12 each having a wide open end 14 and a narrow open end 16. A conical portion is formed between the wide and narrow open ends 14, 16. Preferably, the wide open end 14 further comprises a cylindrical extension portion 18 extending away from the narrow open end 16. The cylindrical extension portion 18 is used to enhance the stability of liquid.

The particle separation member 10 further comprises an entry channel 20 for receiving unclean liquid, and a fluid distribution member 70 for distributing the unclean liquid to the particle separation member 10. Preferably, the entry channel 20 is located outside of the particle collection member 30. In one embodiment, the entry channel 20 has an L shape and comprises an inlet section 22 extending in a radial direction of the particle separation member 10 and an outlet section 24 extending in an axial direction of the particle separation member 10. The inlet section 22 is located in the particle separation member 10 close to the particle collection member 30. The distal end 26 of the outlet section 24 has a conical shape the diameter of which gradually increases in a direction away from the inlet section 22, forming a tapered mouth.

FIG. 3 shows the particle separator with the fluid guiding member and the fluid distribution member removed to show the cavities 12 of the particle separation member 10. Eight cavities 12 surround the outlet section 24 of the entry channel 20. The particle separation member 10 is integrally formed with a plurality of voids and walls formed between the voids as a single injection molding. The voids are respectively used as the cavities 12 and the entry channel 20. The integrally formed particle separation member 10 has good rigidity to thereby reduce vibration when liquid flows through the particle separation member 10. In order to avoid varied deformation at different portions, due to material shrinkage during manufacture or softening during use of hot liquid, portions of the walls formed between the cavities 12 and the entry channel 20 may be removed to reduce the thickness of the walls.

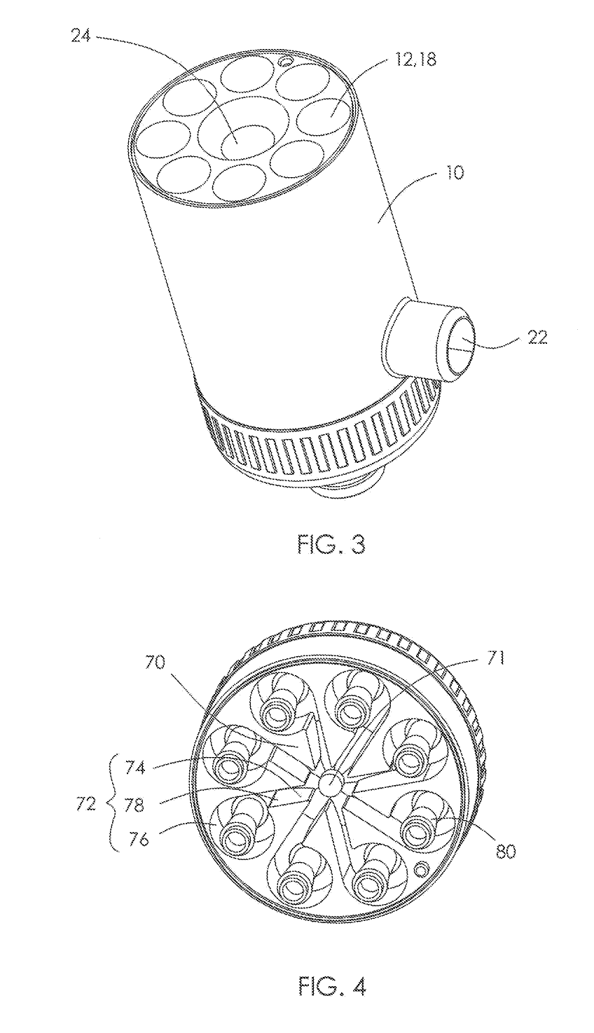

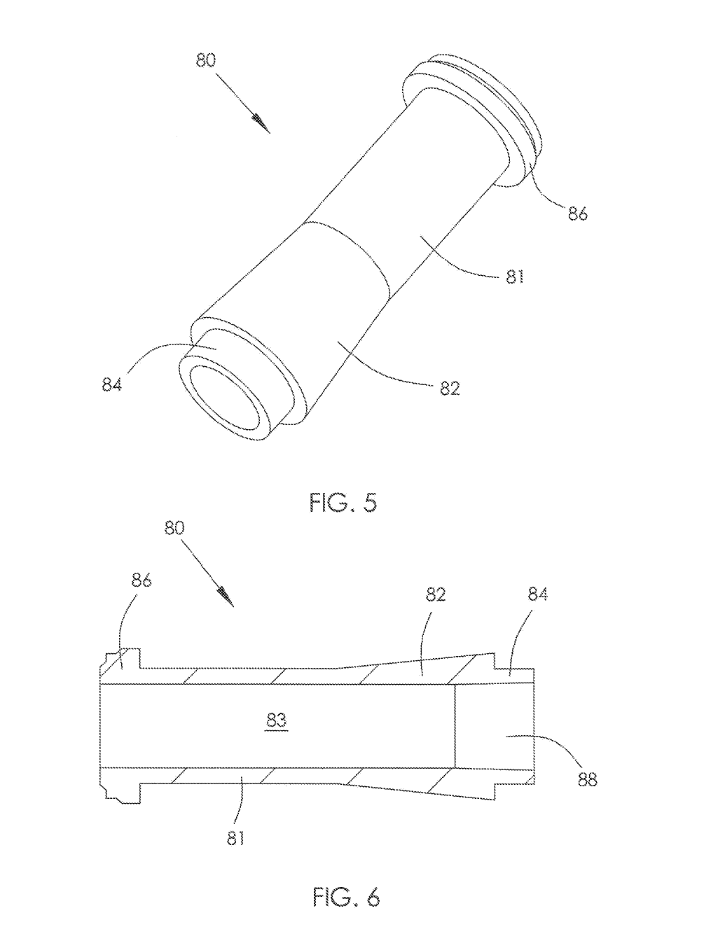

FIG. 4 is a perspective view of the fluid distribution member 70 showing a plurality of distribution passages 72, each having a start section 74 connected to the conical distal end 26 of the entry channel 20, a cylindrical section 76 connected to the extension portion 18 of a corresponding cavity 12, and a transition section 78 connected between the start section 74 and distal section 76. The transition section 78 joins the cylindrical section 76 in a tangential direction of the cylindrical section 76. Preferably, the bottom surface of the transition section 78 facing the particle separation member 10 is curved in order to reduce resistance to the liquid flowing through the fluid distribution member 70. The fluid distribution member 70 further comprises a guiding structure. The guiding structure comprises a protrusion 71 located between the start sections 74 of the distribution passages 72. The protrusion 71 has a curved surface facing the conical distal end 26 of the entry channel 20.

Referring to FIGS. 1, 5 and 6, a vortex finder 80 is arranged at a joint between each cavity 12 and the chamber 52 of the fluid guiding member 50. Each vortex finder 80 comprises a cylindrical body 81, a skirt portion 82 with an outer diameter gradually increasing in a direction away from the fluid guiding member 50 and a central passage 83 forming a path for the liquid to pass from the cavity 12 into the chamber 52. The vortex finder has a distal end 84 having a reduced wall thickness, extending from the end of the skirt portion 82 in a direction away from the fluid guiding member 50. The wall thickness of the distal end 84 is less than the largest thickness of the skirt portion 82, such that a step is formed between the skirt portion 82 and the distal end 84. Preferably, the outer diameter of the distal end 84 is less than the largest outer diameter of the skirt portion 82, such that the surface of the central passage is smooth, optionally having a constant diameter. The skirt portion 82 is located in the cylindrical extension portion 18 of the corresponding cavity 12. The vortex finder 80 further comprises a mounting portion 86 fixed to the fluid guiding member 50.

In use, unclean liquid is introduced into the entry channel 20 from a pressurized source, such as a pump. The liquid flows to the cylindrical extension portions 18 of the cavities 12 via the distribution passages 72. Liquid is directed toward the narrow open ends 16 of the cavities 12 in a helical manner forming a vortex traveling down the cavity. The particles are spun outwardly through centrifugal force and then drop under gravity into the particle collection member 30 via the narrow open ends 16. When the liquid approaches the narrow open ends 16, the vortex changes direction and moves up towards and through the vortex finders and into the chamber 52 of the fluid guiding member 50. At the point where the vortex changes direction the liquid reaches a point of zero vertical motion, at which point the particles carried by the liquid continue to move in a downward direction and drop into the chamber 34 of the particle collection member through the narrow open ends 16. In this embodiment, the cylindrical extension portion 18 of the cavity 12 stabilizes the liquid coming from the fluid distribution member 70. The skirt portion of the vortex finder 82 accelerates the flow of the liquid as the liquid flows through the cylindrical extension portion 18. The distal end 84 of the vortex finder with the reduced wall thickness may create mild turbulence allowing small eddy currents to form at the end of the skirt portion 82 to provide better separation between the down vortex and the up vortex to thereby reduce cross flow of liquid carrying particles entering the central passage of the vortex finders 80 directly. Preferably, the inner surface 88 of the distal end 84 of the vortex finder 80 is slightly tapered to reduce the wall thickness of the end of the vortex finder 80 further.

Referring to FIG. 2, the particle collection member 30 is sealingly connected to the particle separation member 10. The particle collection member 30 comprises a closed chamber 34 for receiving particles 90 from the particle separation member 10. A ring magnet 32 is fixed at the inner surface of the chamber 34 for holding magnetic particles and non-magnetic particles mixed with magnetic particles in the chamber 34. Preferably, the particle collection member 30 is detachably fixed to the particle separation member 10 to allow the magnet 32 to be taken out for cleaning. Alternatively, the magnet 32 may be detachably fixed to an outer surface of the chamber 34. The ring magnet 32 may be replaced by a plurality of individual magnets. The chamber 34 comprises a drain 36 for removing particles from the chamber 34. A valve 38 is arranged at the drain 36 for opening and closing the drain 36.

Preferably, the particle separation member 10, particle collection member 30, fluid guiding member 50 and the fluid distribution member 70 are made of transparent or translucent material such that the inside of the particle separator is visible. Being transparent means that the time for cleaning can be determined by a simple visual inspection. In this embodiment, the particle separation member 10, particle collection member 30, fluid guiding member 50 and the fluid distribution member 70 are made of a plastics material with good thermal stability such as polyurethane. Thus, the particle separator may be used to filter hot water as well as cool or cold water. Preferably, the plastics material is reinforced with mica particles, glass fibers or carbon micro and nano-fibers. Surfaces of the material for guiding liquid may be modified with polymers selected from the group of fluorodecyl polyhedral oligomeric silsesquioxanes.

Alternatively, the particle separation member 10, particle collection member 30, fluid guiding member 50 and the fluid distribution member 70 may be made of metal.

Preferably, pH sensors or pressure sensors may be disposed inside the chamber 52. Pressure sensors may be disposed inside of the particle separation member 10. Monitoring the pH allows the general condition of the water system to be observed. The pressure drop of the particle separator indicates the condition of the device. A large pressure drop indicates a blockage or time for cleaning whereas too low a pressure drop may indicate a blockage elsewhere in the system or even a pump failure.

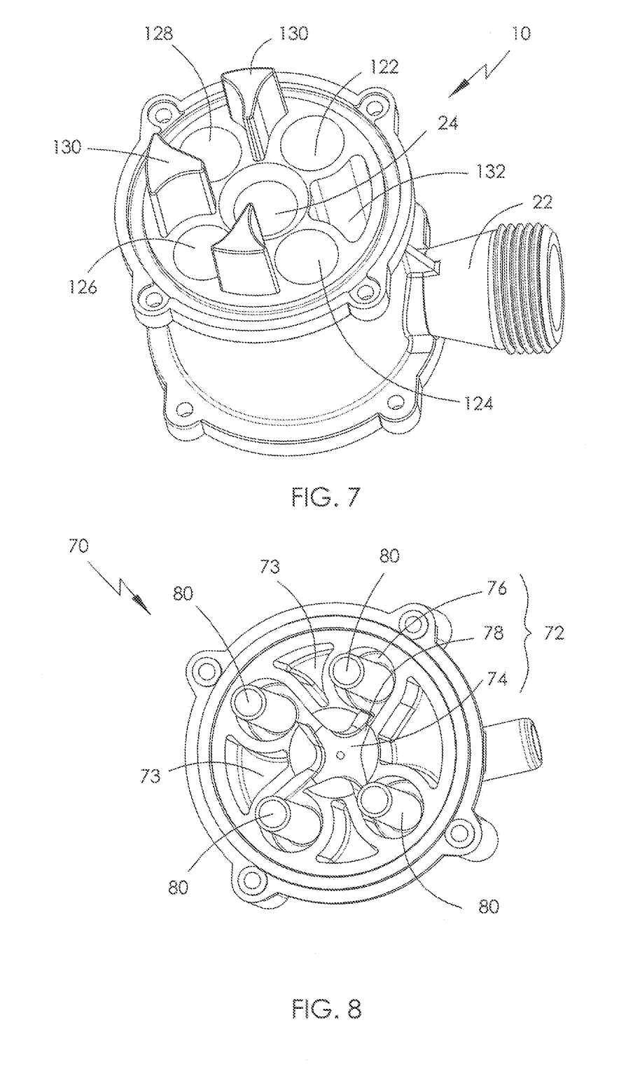

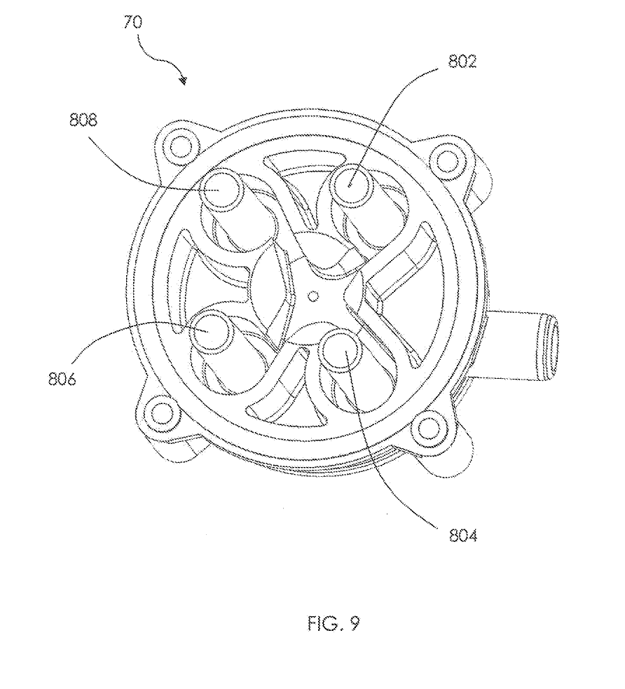

FIG. 7 illustrates a particle separation member according to a second embodiment. The particle separation member 10 includes four cavities 12, indicated by reference numerals 122, 124, 126 and 128. These cavities 12 are arranged unevenly around the outlet section 24 of the particle separation member 10. The inlet section 22 of the entry channel 20 is disposed between the adjacent cavities 122 and 124, thus the distance between cavities 122 and 124 is greater than the distance between cavities 126 and 128. Therefore, the diameter of the inlet section 22 of the entry channel 20 can be larger, to improve the flow of the particle separator. Preferably in order to avoid varied deformation at different portions, some material between adjacent cavities was removed so as to form four openings 132, thus the width of the walls of each cavity 122-128 and inlet section 20 are approximately the same. Referring to FIG. 8, four openings 73 are formed in the fluid distribution member 70 respectively corresponding to openings 132 in the particle separation member 10. Four connecting portions 130 are inserted into the space formed by openings 132 and corresponding openings 73 to avoid relative radial movement between the particle separation member 10 and the fluid distribution member 70. The connecting portions 130 may be made of rubber, or other appropriate material.

FIG. 8 illustrates a fluid distribution member 70 corresponding to the particle separation member of FIG. 7. Referring FIGS. 2 and 8, the fluid distribution member 70 includes four distribution passages 72, each having a start section 74 connected to the conical distal end 26 of the entry channel 20, a cylindrical section 76 connected to the extension portion 18 of a corresponding cavity 12, and a transition section 78 connected between the start section 74 and distal section 76. The transition section 78 joins the cylindrical section 76 in a tangential direction of the cylindrical section 76. The liquid flows in a direction as indicated by arrows in FIG. 2, from the entry channel 20, through distribution passages 72 and into cavities 12. Each transition section 78 joins the cylindrical section 76 in a clockwise tangential direction of the cylindrical section 76. It is understood that each transition section 78 can also join the cylindrical section 76 in an anti-clockwise tangential direction of the cylindrical section 76.

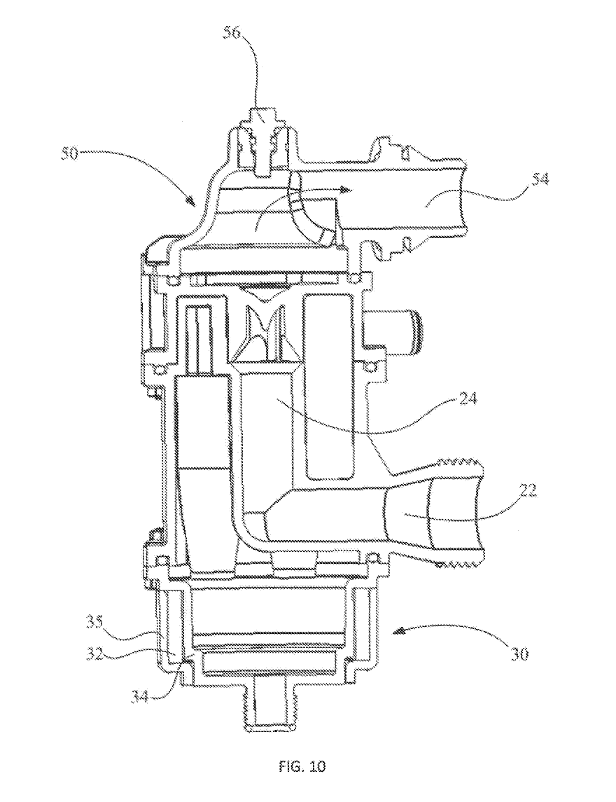

FIG. 9 illustrates another fluid distribution member in accordance with a further embodiment of the present invention. In this embodiment, each distribution passage 72 has the start section 74, the cylindrical section 76 and the transition section 78 connected there between. There are four vortex finders 80, indicated by reference numerals 802-808. The transition sections 78 join the cylindrical sections 76 coupled with vortex finders 802 and 808 in an anti-clockwise tangential direction of the cylindrical sections 76. The transition sections 78 join the cylindrical sections 76 coupled with vortex finders 804 and 806 in a clockwise tangential direction of the cylindrical sections 76. Thus, the rotational direction of liquid flowing through vortex finders 804 and 806 is symmetrical with the rotational direction of liquid flowing through vortex finders 802 and 808.

In this embodiment, the four vortex finders 802, 804, 806 and 808 are disposed corresponding to the cavities 12 of the particle separation member 10. The distance between vortex finders 802 and 804 is bigger than the distance between vortex finders 806 and 808.

FIG. 10 is a sectional view of a particle separator in accordance with another embodiment of the present invention. The particle collection member 30 includes a magnet cover 35 covering the chamber 34 of the particle collection member 30. The ring magnet 32 is fixed to an inner surface of the magnet cover 35. Thus, the magnet cover 35 is detachably fixed to the particle separation member 10 to allow the magnet 32 to be taken out for replacement or cleaning.

In this embodiment, the outlet 54 is disposed at side of the fluid distribution member 50 and parallel with the inlet section 22 of the particle separation member 10. A gas-liquid separator 56 is disposed on the top of the fluid guiding member 50 so as to separate out any air in the liquid.

In the description and claims of the present application, each of the verbs “comprise”, “include”, “contain” and “have”, and variations thereof, are used in an inclusive sense, to specify the presence of the stated item or feature but do not preclude the presence of additional items or features.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of example only, and various other modifications will be apparent to persons skilled in the field without departing from the scope of the invention as defined by the appended claims.

1. A particle separator comprising:
a particle separation member configured to separate particles from unclean liquid, the particle separation member comprising an entry channel and a plurality of cavities each having a narrow open end, a wide open end and a conical part between the narrow and wide open ends;
a fluid distribution member configured to distribute the unclean liquid to the cavities;
a particle collection member in communication with the narrow open ends of the cavities and arranged to collect particles separated from the liquid;
a fluid guiding member configured to guide liquid from the particle separation member to an outlet of the device; and
a plurality of vortex finders disposed between the wide open end of each of the cavities of the particle separation member and the fluid guiding member;
wherein the entry channel comprises an inlet section extending in a radial direction of the particle separation member, and an outlet section extending in an axial direction of the particle separation member; and
the inlet section is disposed between two adjacent cavities of the particle separation member, and the distance between said two adjacent cavities greater than the distance between other adjacent cavities.

2. The particle separator of claim 1, wherein the inlet section is located outside of a chamber of the particle collection member.

3. The particle separator of claim 1, wherein the wide open end of each cavity further comprises a cylindrical extension portion, and each vortex finder is disposed in the cylindrical extension portion of a corresponding cavity.

4. The particle separator of claim 1, wherein the outlet section of the entry channel has a conical distal end, the diameter of which gradually increases in a direction away from the inlet section, and the start sections of the distribution passages are connected to the conical distal end.

5. The particle separator of claim 4, wherein the fluid distribution member further comprises a protrusion located between the start sections of the distribute passages, the protrusion having a curved surface facing the conical distal end of the entry channel.

6. The particle separator of claim 1, wherein the fluid distribution member comprises a plurality of distribution passages each having a start section, a cylindrical section connected to the cylindrical extension portion of a corresponding cavity, and a transition section connecting the start section to the cylindrical section, the transition section joining the cylindrical section in a tangential manner.

7. The particle separator of claim 6, wherein a bottom surface of the transition section facing the particle separation member is curved.

8. The particle separator of claim 1, wherein pressure sensors are respectively disposed in the particle separation member and the fluid guiding member.

9. The particle separator of claim 1, wherein a pH sensor is disposed in the fluid guiding member.

10. The particle separator of claim 1, wherein each vortex finder has a cylindrical body with a central passage connecting the cavities with the fluid guiding member, a skirt portion and a distal end adjacent the skirt portion and having a reduced wall thickness, the skirt portion being located at the wide open end of the corresponding cavity.

11. The particle separator of claim 10, wherein an outer surface of the distal end of each vortex finder forms a step with the skirt portion.

12. The particle separator of claim 10, wherein the distal end of each vortex finder has an inclined inner surface.

13. The particle separator of claim 1, wherein the particle collection member comprises a chamber, a magnet cover detachably covers the chamber and a ring magnet is fixed to an inner surface of the magnet cover.

14. The particle separator of claim 1, wherein pressure sensors are respectively disposed in the particle separation member and the fluid guiding member.

15. The particle separator of claim 1, wherein the particle separation member, fluid guiding member, and particle collection member are made from transparent or translucent materials.

16. The particle separator of claim 15, wherein the materials of the particle separation member are thermally stable plastics materials reinforced with mica particles, glass fibers or carbon micro and nano-fibers.

17. The particle separator of claim 16, wherein surfaces for guiding liquid are modified with polymers selected from the group of fluorodecyl polyhedral oligomeric silsesquioxanes.
